(19) United States
(12) Patent Application Publication
(10) Pub. No.: US 2013/0210973 A1
(43) Pub. Date: Aug. 15, 2013

(54) PROCESS FOR IMPROVING THE FLOW PROPERTIES OF POLYMER MELTS

(71) Applicant: BASF SE, (US)

(72) Inventors: Klaus Stoll, Binzen (DE); Kurt Hoffmann, Weitenau-Steinen (DE); Bruno Rotzinger, Delemont (CH); Hans-Werner Schmidt, Bayreuth (DE)

(73) Assignee: BASF SE, LUDWIGSHAFEN (DE)

(21) Appl. No.: 13/717,804

(22) Filed: Dec. 18, 2012

Related U.S. Application Data
(63) Continuation of application No. 11/992,175, filed on Jul. 16, 2009, now abandoned.

(30) Foreign Application Priority Data
Sep. 28, 2005 (EP) 05108956.3

(51) Int. Cl. C08K 5/20; C08K 5/1575

(52) U.S. Cl. CPC C08K 5/20; C08K 5/1575
USPC 524/108; 524/585; 524/586; 524/229

(57) ABSTRACT

A process for improving the flow properties of a melt containing a thermoplastic polymer, which comprises incorporating 0.005% to 0.5% by weight, relative to the weight of the thermoplastic polymer, of one or more additives selected from the group consisting of organic and inorganic compounds with needle-like morphology in their solid state into said thermoplastic polymer prior to or during melt processing.

This application is a continuation of U.S. application Ser. No. 11/992,175, abandoned, which is a 371 of international app. No. PCT/EP2006/066566, filed Sep. 21, 2006, the contents of which applications are incorporated by reference.

The present invention relates to a process for improving the flow properties of a polymer melt formed from a thermoplastic polymer, the use of particular additives, for example amide or sorbitol derivatives, to improve the flow properties of a polymer melt formed from a thermoplastic polymer and the use of said additives as processing aids.

### BACKGROUND OF THE INVENTION

The flow characteristics of polymer melts have paramount significance for the design and operating conditions of industrial processing equipment, and may tremendously affect the overall properties of manufactured polymer articles. Polymer melts typically exhibit a non-Newtonian behaviour; i.e. their apparent viscosity is strongly dependent from the shear rate applied during moving or feeding polymers at temperatures well above their melting points. High shear rates result typically from high levels of mechanical energy (pressure and shear) applied for the purpose of extruding, feeding or any sort of transporting polymer melts in the course of the shape-giving process. Furthermore, high shear rates may equally result from high flow rates or high flow velocities, when polymer melts are forced to pass through narrow dies, nozzles, cylinder profiles and the like, which can be of round, rectangular, annular, slit-like or any other irregular shape or low gap-width cross sections.

If inadequate attention is paid to the peculiar rheological properties of polymer melts, this may eventually lead to several negative, and therefore, undesired consequences in the aesthetic or mechanical polymer properties, which are well known from extrusion processes, in particular in the manufacture of thin-walled profiles, cast or blown films. Various structural defects are commonly referred to as shark-skin, snake-skin or orange-peel. These terms are figurative and self-explanatory descriptions of melt-fracture phenomena, which become more and more apparent, when higher and higher shear rates cause visible roughness or even cracks and crevices on the polymer surface, so that the optical and physical properties of the manufactured polymer article are heavily deteriorated. Such defects become dramatically pronounced during melt processing of polymers into thin-walled articles, since the shear rate (“γ”, measured in sec⁻¹) is inversely proportional to the gap-width of a die (width or distance “d”), which the melt has to pass; i.e. γ˜1/d.

Nucleating agents are described by L. M. Sherman in Plastics Technology July 2002, pages 1-4 (XP002381730), and in WO-A-2004/072,168. Mineral filled moldable thermoplastic compositions containing 5 to 70 weight % of a fine needle like particulate mineral additive are disclosed in U.S. Pat. No. 5,965,655.

Several options to reduce melt fracture or related imperfections on extruded polymers are well known in the art. For example, U.S. Pat. No. 3,125,547 teaches the use of small amounts of fluoro-polymers to achieve smooth surfaces during melt processing at high extrusion speed. Several other documents, e.g. U.S. Pat. No. 3,222,314, U.S. Pat. No. 4,013,622, U.S. Pat. No. 4,540,538 and US-A-2005/0,070,644, describe the beneficial use of polyethylene glycols of different molecular weights, especially for the manufacture of polyethylene films. Improved processability of polyolefin melts is claimed therein, so that improved manufacturing conditions and better quality of the finished products are ensured.

Despite the technical viability of the aforementioned options to minimize imperfections or damages on extruded polymers, their numerous drawbacks are also well known in the polymer processing industry. Fluoro-polymers or polyethylene glycol processing aids have little or no compatibility with most polymers. They serve or function as lubricants in the melt feeding process; i.e. they generate a slippage effect, which may eventually diminish the imperfections caused under high shear conditions. In consequence thereof, these incompatible lubricants contaminate the metal surfaces of the processing equipment, are very difficult to remove or to clean away, are extremely prone to form deposits on die-lips, niches or colder equipment parts and, thus, comprise a constant source of processing difficulties related to cross-contaminations, decomposition, charring and even accelerated degradation of the polymer as such.

In addition, onset and fade-away of these lubrication effects occur not immediately upon dosing, which makes it obviously difficult to operate processing equipment under steady and constant conditions. These effects are always retarded, i.e. substantial lead-time and/or higher dosing are needed to achieve the desired lubrication. Furthermore, making these effects disappear again, e.g. needed when polymers or formulations are changed, is even more difficult to achieve requiring big amounts of purging material (=waste) or even dismantling and full cleaning of major equipment parts after prolonged operation periods.

In addition to that, the presence of such lubricating processing aids on the surface of manufacture end-articles is highly undesirable for several other reasons. They affect the polymers' typical surface characteristics, e.g. gloss, sealability, stickiness, wettability, printability and the like, and may even further chemically interact with stabilizers or other additives used to safeguard the service life of polymer articles for the intended applications.

The selected additives used according to the present invention do not exhibit the drawbacks of the aforementioned lubricating agents, and are extremely useful to improve the flow characteristics of polymer melts.

In sharp contrast to conventional polymer processing aids, they have rather a sufficient to good compatibility with polymer melts at typical processing temperatures, i.e. at least 15° C. higher than the melting point of the polymers at stake as determined by conventional DSC testing at 10° C./min during heating and cooling. The affinity of said additives towards the respective polymers is further expressed in their effect on the crystallization temperature of the polymer “T_{c}”, which is increased by the presence of said additives by at least 1° C., more preferably by 2-5° C. or even more versus the respective reference polymer not containing said additives (DSC testing at 10° C./min during heating and cooling). The usefulness of the additives used according to the present invention is significantly reflected in this interaction with the host polymer, easily accessible by DSC testing.

The most important feature for the selection of suitable additives used according to the present invention, however, is their crystalline morphology. Said additives exhibit columnar, needle-like structures in their solid state with a ratio of “length/diameter”>3. These additives can be obtained in their solid form in-situ from synthesis, crystallized from solution, by vapour phase deposition and the like. They can further be precipitated from polymeric or non-polymeric melts during processing and subsequent cooling. Owing to their—at least partial—compatibility with polymer melts, the particle size or particle size distribution of said additives is only of minor importance in contrast to their crystalline morphology as described above. The additives used according to the present invention may even completely dissolve during melt processing of the polymers, in which they are applied, and again recrystallize in their needle-like shapes well above the melting or crystallization temperature of the respective polymer.

It has now surprisingly been found that the additives used according to the present invention, fulfilling all criteria mentioned above, significantly improve the flowability of polymer melts, when incorporated therein at fairly low concentrations of e.g. 0.005% to 0.5% by weight, preferably 0.01% to 0.25% by weight, relative to the weight of the polymer melt. Especially under the adverse processing conditions of high shear and/or high flow rates, common imperfections on polymer surfaces, like for example the melt-fracture phenomena referred to as shark-skin, snake-skin or orange-peel, can be significantly reduced or even entirely avoided. At the same time, the typical drawbacks of conventional lubricating processing aids (such as fluoropolymers or polyethylene glycols) are completely circumvented, and high stability, processing safety and end-product quality is achieved.

It ought to be borne in mind that this novel technology allows, furthermore, to reduce the specific amount of energy required for the melt processing steps and/or to enhance specific throughput, so that the total shape giving process can be pursued in a more economic way and under well controllable conditions of steady and stable operations on any type of melt processing equipment.

### SUMMARY OF THE INVENTION

Thus, the present invention relates to

a process for improving the flow properties of a melt containing a thermoplastic polymer, which comprises incorporating 0.005% to 0.5% by weight, relative to the weight of the thermoplastic polymer, of one or more additives selected from the group consisting of organic and inorganic compounds with needle-like morphology in their solid state into said thermoplastic polymer prior to or during melt processing.

### BRIEF DESCRIPTION OF THE DRAWINGS

FIG. 1 is an image of additive IA-1 obtained with a scanning electron microscope (SEM) and is discussed in Example 1.

FIG. 2 is an image of additive IB-1 obtained with a scanning electron microscope and is discussed in Example 2.

FIG. 3 is an image of additive ID-1 obtained with a scanning electron microscope and is discussed in Example 3.

### DETAILED DESCRIPTION OF THE INVENTION

Preferred Embodiments of the Process According to the Present Invention are

a) A process as defined above, wherein the needle-like morphology of the pure additive in its solid state is a columnar structure exhibiting an average length/diameter ratio of more than 3, in particular more than 4 or 5. Of particular interest is an average length/diameter ratio in a range of 3/1 to 500/1 or 4/1 to 200/1 or 5/1 to 100/1 or 5/1 to 90/1 or 8/1 to 80/1.

b) A process as defined above, wherein the additive has a melting point which is at least 30° C. higher, preferably 60° C. higher, for example 30° to 330° C. or 60° to 330° C. or 100° to 330° C. higher than the melting point of the thermoplastic polymer.

c) A process as defined above, wherein the additive enhances the crystallization temperature T_{c} of the thermoplastic polymer by at least 1° C., preferably by at least 2° C. or by at least 5° C., for example by 2° to 22° C. or 5° to 22° C. or 2° to 5° C. The crystallization temperature T_{c} of the thermoplastic polymer is determined by common DSC (Differential Scanning calorimetry) techniques referring to the peak temperature measured during cooling of the polymer melt from at least T>T_{c}+100° C., typically at a rate of 10° C./min.

d) A process as defined above, wherein the additive is an organic compound containing polar moieties enabled to undergo long-range polar-polar interaction by hydrogen bonding.

Examples of suitable polar moieties are —OH, >NH, —NH₂, >N—OH, —NH—NH—, >N—NH₂, >P(O)(OH), —SH, —S—OH, —S(O)(OH), —S(O)₂(OH), and furthermore >C═O, ≡C—O—, >C═S, ≡C—S—, ≡C—S(O)—, ≡C—S(O)₂—, —NO, —NO₂, —N═N—, halogen and pseudo-halogen.

e) A process as defined above, wherein the additive is an organic compound containing polar moieties and shielding non-polar hydrophobic groups on the outer molecular sphere.

Examples of non-polar hydrophobic groups on the outer molecule sphere are hydrocarbon groups which can be saturated, unsaturated, mono- or polycyclic and may optionally contain one or more heteroatoms within or attached to their sceleton. Methyl, ethyl or any higher linear or branched alkyl groups are preferred.

The additive used according to the present invention is preferably an organic compound with needle-like morphology in its solid state, in particular a compound of the formula (IA), (IB), (IC) or (ID)

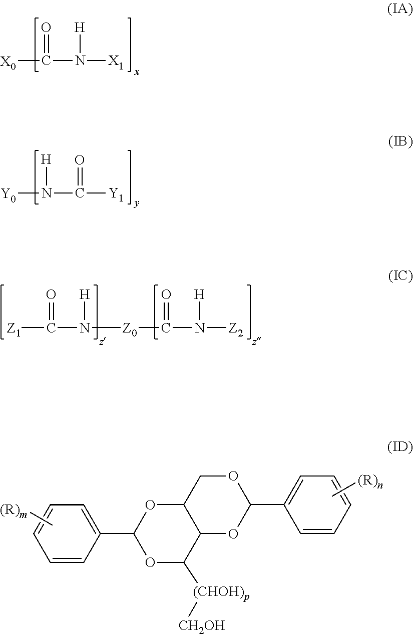

wherein

x and y are an integer from 2 to 6;

z′ and z″ independently of one another are an integer from 1 to 5 with the proviso that the sum of z′ and z″ is an integer from 2 to 6;

p is zero or 1;

m and n independently of one another are an integer from zero to 3;

X₀ is a residue which is formed by elimination of x carboxyl groups of a saturated or unsaturated aliphatic polycarboxylic acid having 3 to 25 carbon atoms,

a residue which is formed by elimination of x carboxyl groups of a saturated or unsaturated alicyclic polycarboxylic acid having 7 to 25 carbon atoms or

a residue which is formed by elimination of x carboxyl groups of an aromatic polycarboxylic acid having 8 to 25 carbon atoms; any of said polycarboxylic acids optionally contains further hetero atoms in its sceleton;

the radicals X₁ independently of one another are

C₁-C₂₀alkyl unsubstituted or substituted by one or more hydroxy, amino and/or nitro groups;

C₂-C₂₀alkenyl unsubstituted or substituted by one or more hydroxy, amino and/or nitro groups;

C₂-C₂₀alkyl interrupted by oxygen or sulfur;

C₃-C₁₂cycloalkyl unsubstituted or substituted by one or more C₁-C₂₀alkyl;

(C₃-C₁₂cycloalkyl)-C₁-C₁₀alkyl unsubstituted or substituted by one or more C₁-C₂₀alkyl;

bis[C₃-C₁₂cycloalkyl]-C₁-C₁₀alkyl unsubstituted or substituted by one or more C₁-C₂₀alkyl;

a bicyclic or tricyclic hydrocarbon radical with 5 to 20 carbon atoms unsubstituted or substituted by one or more C₁-C₂₀alkyl;

phenyl unsubstituted or substituted by one or more radicals selected from C₁-C₂₀alkyl, C₁-C₂₀alkoxy, C₁-C₂₀alkylamino, di(C₁-C₂₀alkyl)amino, amino, hydroxy and nitro;
phenyl-C₁-C₂₀alkyl unsubstituted or substituted by one or more radicals selected from C₁-C₂₀alkyl, C₃-C₁₂cycloalkyl, phenyl, C₁-C₂₀alkoxy, amino, hydroxy and nitro;

phenylethenyl unsubstituted or substituted by one or more C₁-C₂₀alkyl;

biphenyl-(C₁-C₁₀alkyl) unsubstituted or substituted by one or more C₁-C₂₀alkyl; naphthyl unsubstituted or substituted by one or more C₁-C₂₀alkyl;

naphthyl-C₁-C₂₀alkyl unsubstituted or substituted by one or more C₁-C₂₀alkyl;

naphthoxymethyl unsubstituted or substituted by one or more C₁-C₂₀alkyl;

biphenylenyl, flourenyl, anthryl;

a 5- to 6-membered heterocyclic radical unsubstituted or substituted by one or more C₁-C₂₀alkyl;

a C₁-C₂₀hydrocarbon radical containing one or more halogen or pseudo-halogen;

tri(C₁-C₁₀alkyl)silyl; or

tri(C₁-C₁₀alkyl)silyl(C₁-C₁₀alkyl);

Y₀ is a residue which is formed by elimination of y amino groups of a saturated or unsaturated aliphatic polyamine having 3 to 25 carbon atoms,

a residue which is formed by elimination of y amino groups of a saturated or unsaturated alicyclic polyamine having 6 to 25 carbon atoms or

a residue which is formed by elimination of y amino groups of an aromatic polyamine having 6 to 25 carbon atoms; any of said polyamines optionally contains further hetero atoms in its sceleton;

the radicals Y₁ independently of one another have one of the definitions of X₁;

Z₀ is a residue which is formed by elimination of z′ amino groups and z″ carboxyl groups of an unsaturated or saturated aliphatic amino carboxylic acid having 2 to 25 carbon atoms,

a residue which is formed by elimination of z′ amino groups and z″ carboxyl groups of a saturated or unsaturated alicyclic amino carboxylic acid having 7 to 25 carbon atoms or

a residue which is formed by elimination of z′ amino groups and z″ carboxyl groups of an aromatic amino carboxylic acid having 7 to 25 carbon atoms; any of said amino carboxylic acids optionally contains further hetero atoms in its sceleton;

the radicals Z₁ and Z₂ independently of one another have one of the definitions given for X₁; and

the radicals R independently of one another are C₁-C₈alkyl, C₁-C₈alkoxy, hydroxy, halogen, pseudo-halogen, C₁-C₈alkylthio, C₁-C₈alkylsulfoxy or 2 radicals R form together with 2 adjacent carbon atoms of the unsaturated parent ring a 5- to 7-membered carbocyclic or heterocyclic ring.

Examples of a saturated or unsaturated aliphatic polycarboxylic acid having 3 to 25, preferably 3 to 16, in particular 4 to 12, carbon atoms and x carboxyl groups and optionally containing further hetero atoms in its sceleton are malonic acid, diphenylmalonic acid, succinic acid, phenylsuccinic acid, diphenylsuccinic acid, glutaric acid, 3,3-dimethylglutaric acid, adipic acid, pimelic acid, suberic acid, azelaic acid, sebacic acid, 1,12-dodecanedioic acid, 1,14-tetradecanedioic acid, 1,18-octadecanedioic acid, citric acid, methanetricarboxylic acid, tricarballylic acid, propenetricarboxylic acid, pentanetricarboxylic acid, ethanetetracarboxylic acid, propanetetracarboxylic acid, pentanetetracarboxylic acid, butanetetracarboxylic acid (particularly 1,2,3,4-butanetetracarboxylic acid), dodecanetetracarboxylic acid, pentanepentacarboxylic acid, tetradecanehexacarboxylic acid, ethylenediaminetetraacetic acid, nitrilotriacetic acid, ethyleneglycolbis[beta-aminoethylether]N,N,N′,N′-tetraacetic acid, diethylenetriaminepentaacetic acid, N-hydroxyethylethylenediamine-N,N′,N′-triacetic acid, 1,3-diaminopropane-2-ol-N,N,N′,N′-tetraacetic acid, 1,2-diaminopropane-N,N,N′,N′-tetraacetic acid, triethylenetetraminehexaacetic acid, nitrilotripropionic acid, 1,6-hexanediaminetetraacetic acid, N-(2-carboxyethyl)iminodiacetic acid and the like.

Examples of a saturated or unsaturated alicyclic polycarboxylic acid having 7 to 25, preferably 8 to 16, carbon atoms and x carboxyl groups and optionally containing further hetero atoms in its sceleton are 1,2-cyclohexane dicarboxylic acid, 1,4-cyclohexanedicarboxylic acid, 1,4-cyclohexanediacetic acid, cyclohexanetricarboxylic acid, cyclobutanetetracarboxylic acid, cyclopentanetetracarboxylic acid, cyclohexanetetracarboxylic acid, tetrahydrofurantetracarboxylic acid, 5-(succinic acid)-3-methyl-3-cylohexene-1,2-dicarboxylic acid, bicyclo[2,2,2]octa-7-ene-2,3,5,6-tetracarboxylic acid, cyclohexanehexacarboxylic acid, 5,6,9,10-tetracarboxytricyclo[6.2.2.0.sup.2,7]dodeca-2,11-diene which may have a lower alkyl group as a substituent (such as a methyl group at the 3-, 8-11- or 12-position), 1,2-cyclohexanediaminetetraacetic acid, 2,3,5-tricarboxycyclopentylacetic acid, 6-methyl-4-cyclohexene-1,2,3-tricarboxylic acid, 3,5,6-tricarboxynorbornene-2-acetic acid, thiobis(norbornene-2,3-dicarboxylic acid), bicyclo[4.2.0]octane-3,4,7,8-tetracarboxylic acid, 1,1′-bicyclopropane-2,2′,3,3′-tetracarboxylic acid, 1,2-bis(2,3-dimethyl-2,3-dicarboxycyclobutyl)ethane, pyrazine-2,3,5,6-tetracarboxylic acid, tricyclo[4.2.2.0.sup.2,5]decane-9-ene-3,4,7,8-tetracarboxylic acid, 3,4-dicarboxy-1,2,3,4-tetrahydro-1-naphthalenesuccinic acid which may have a lower alkyl group as a substituent (such as a methyl group at the 1-, 5-, 6- or 7-position), 2,3,4,5,6,7,12,13-octahydrophenanthrene-3,4,5,6-tetracarboxylic acid and the like.

Examples of an aromatic polycarboxylic acid having 8 to 25, preferably 8 to 22, in particular 8 to 17, carbon atoms and x carboxyl groups and optionally containing further hetero atoms in its sceleton are p-phenylenediacetic acid, p-phenylenediethanoic acid, phthalic acid, 4-tert-butylphthalic acid, isophthalic acid, 5-tert-butylisophthalic acid, terephthalic acid, 1,8-naphthalic acid, 1,4-naphthalenedicarboxylic acid, 2,6-naphthalenedicarboxylic acid, 2,7-naphthalenedicarboxylic acid, diphenic acid, 3,3′-biphenyldicarboxylic acid, 4,4′-biphenyldicarboxylic acid, 4,4′-binaphthyldicarboxylic acid, bis(3-carboxyphenyl)methane, bis(4-carboxyphenyl)methane, 2,2-bis(3-carboxyphenyl)propane, 2,2-bis(4-carboxyphenyl)propane, 3,3′-sulfonyldibenzoic acid, 4,4,-sulfonyldibenzoic acid, 3,3′-oxydibenzoic acid, 4,4′-oxydibenzoic acid, 3,3′-carbonyldibenzoic acid, 4,4′-carbonyldibenzoic acid, 3,3′-thiodibenzoic acid, 4,4′-thiodibenzoic acid, 4,4′-(p-phenylenedioxy)dibenzoic acid, 4,4′-isophthaloyldibenzoic acid, 4,4′-terephthaloyldibenzoic acid, dithiosalicylic acid, benzenetricarboxylic acid such as trimesic acid, benzenetetracarboxylic acid, benzophenonetetracarboxylic acid, biphenyltetracarboxylic acid, diphenylethertetracarboxylic acid, diphenylsulfonetetracarboxylic acid, diphenylmethanetetracarboxylic acid, perylenetetracarboxylic acid, naphthalenetetracarboxylic acid, 4,4′-dinaphthalic acid, benzidine-3,3′-dicarboxyl-N,N′-tetraacetic acid, diphenylpropanetetracarboxylic acid, anthracenetetracarboxylic acid, phthalocyaninetetracarboxylic acid, ethyleneglycol-trimellitic acid diester, benzenehexacarboxylic acid, glycerine-trimellitic acid triester and so on.

Examples of linear or branched alkyl having up to 20 carbon atoms and being optionally substituted by one or more hydroxy, amino and/or nitro groups are ethyl, n-propyl, 1-methylethyl, n-butyl, 2-methylpropyl, 1-methylpropyl, tert-butyl, pentyl, 1-methylbutyl, 2-methylbutyl, 3-methylbutyl, 1,1-dimethylpropyl, 1-ethylpropyl, tert-butylmethyl, hexyl, 1-methylpentyl, heptyl, isoheptyl, 1-ethylhexyl, 2-ethylpentyl, 1-propylbutyl, octyl, nonyl, isononyl, neononyl, 2,4,4-trimethylpentyl, undecyl, tridecyl, pentadecyl, heptadecyl, hydroxymethyl, 1-hydroxyethyl and 1-aminoethyl. Branched C₃-C₁₀alkyl is particularly preferred. One of the preferred meanings of the radicals X₁, Y₁, Z₁ and Z₂ is branched C₃-C₁₀alkyl with a quaternary C atom in position 1, in particular —C(CH₃)₂—H or —C(CH₃)₂—(C₁-C₇alkyl).

Examples of C₂-C₂₀alkyl interrupted by oxygen or sulfur are t-butoxymethyl, t-butoxyethyl, t-butoxypropyl, t-butoxybutyl, (H₃C)₃C—S—CH₂—, (H₃C)₃C—S—C₂H₄—, (H₃C)₃C—S—C₃H₆— and (H₃C)₃C—S—C₄H₈—.

Examples of C₁-C₈alkoxy are methoxy, ethoxy, propoxy, butoxy, pentyloxy, hexyloxy, heptyloxy and octyloxy. Methoxy is particularly preferred.

Examples of C₁-C₈alkylthio are methylthio, ethylthio, propylthio, butylthio, pentylthio, hexylthio, heptylthio and octylthio.

Examples of C₁-C₈alkylsulfoxy are methylsulfoxy, ethylsulfoxy, propylsulfoxy, butylsulfoxy, pentylsulfoxy, hexylsulfoxy, heptylsulfoxy and octylsulfoxy.

Examples of C₂-C₂₀alkenyl unsubstituted or substituted by one or more hydroxy, amino and/or nitro groups are 9-decenyl, 8-heptadecenyl, 11-hydroxy-8-heptadecenyl and 11-amino-8-heptadecenyl.

Examples of C₃-C₁₂cycloalkyl unsubstituted or substituted by one or more C₁-C₂₀alkyl, e.g. 1, 2, 3 or 4 C₁-C₄alkyl, are cyclopropyl, 3-methylcyclopropyl, 2,2,3,3-tetramethylcyclopropyl, cyclobutyl, cyclopentyl, cyclohexyl, 1-methylcyclohexyl, 2-methylcyclohexyl, 3-methylcyclohexyl, 4-methylcyclohexyl, 4-tert-butylcyclohexyl and cycloheptyl.

Examples of (C₃-C₁₂cycloalkyl)-C₁-C₁₀alkyl unsubstituted or substituted by one or more C₁-C₂₀alkyl, e.g. 1, 2 or 3 C₁-C₄alkyl, are cyclopentylmethyl, 2-cyclopentylethyl, cyclohexylmethyl, 2-cyclohexylethyl, 3-cyclohexylpropyl, 4-cyclohexylbutyl and (4-methylcyclohexyl)methyl.

An example of bis[C₃-C₁₂cycloalkyl]-C₁-C₁₀alkyl unsubstituted or substituted by one or more C₁-C₂₀alkyl, e.g. 1, 2 or 3 C₁-C₄alkyl, is dicyclohexylmethyl.

Examples of a bicyclic or tricyclic hydrocarbon radical with 5 to 20 carbon atoms unsubstituted or substituted by one or more C₁-C₂₀alkyl, e.g. 1, 2 or 3 C₁-C₄alkyl, are

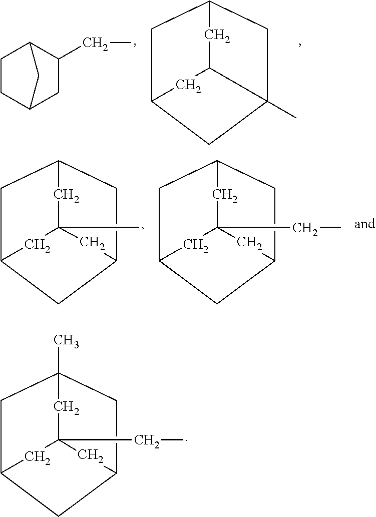

Examples of phenyl unsubstituted or substituted by one or more radicals selected from C₁-C₂₀alkyl, C₁-C₂₀alkoxy, C₁-C₂₀alkylamino, di(C₁-C₂₀alkyl)amino, amino, hydroxy and nitro, preferably C₁-C₄alkyl, C₁-C₄alkoxy, C₁-C₄alkylamino, di(C₁-C₄alkyl)amino, hydroxy and nitro, are phenyl, 3-methylphenyl, 3-methoxyphenyl, 4-methylphenyl, 4-ethylphenyl, 4-propylphenyl, 4-isopropylphenyl, 4-tert-butylphenyl, 4-isopropoxyphenyl, 2,3-dimethoxyphenyl, 2-nitrophenyl, 3-methyl-6-nitrophenyl, 4-dimethylaminophenyl, 2,3-dimethylphenyl, 2,6-dimethylphenyl, 2,4-dimethylphenyl, 3,4-dimethylphenyl, 3,5-dimethylphenyl, 3,5-di-tert-butylphenyl, 2,4,6-trimethylphenyl and 3,5-di-tert-butyl-4-hydroxyphenyl.

Examples of phenyl-C₁-C₂₀alkyl unsubstituted or substituted by one or more radicals selected from C₁-C₂₀alkyl, C₃-C₁₂cycloalkyl, phenyl, C₁-C₂₀alkoxy, amino, hydroxy and nitro, preferably C₁-C₄alkyl, C₃-C₆cycloalkyl, phenyl, C₁-C₄alkoxy and hydroxy, are benzyl, α-cyclohexylbenzyl, diphenylmethyl, 1-phenylethyl, α-hydroxybenzyl, 2-phenylethyl, 2-phenylpropyl, 3-phenylpropyl, 3-methylbenzyl, 3,4-dimethoxybenzyl and 2-(3,4-dimethoxyphenyl)ethyl.

An example of phenylethenyl unsubstituted or substituted by one or more C₁-C₂₀alkyl, e.g. 1, 2 or 3 C₁-C₄alkyl, is 2-(4-methylphenyl)ethenyl.

An example of biphenyl-(C₁-C₁₀alkyl) unsubstituted or substituted by one or more C₁-C₂₀alkyl, e.g. 1, 2 or 3 C₁-C₄alkyl, is 4-biphenylmethyl.

Examples of naphthyl unsubstituted or substituted by one or more C₁-C₂₀alkyl, e.g. 1, 2 or 3 C₁-C₄alkyl, are 1-naphthyl and 2-naphthyl.

Examples of naphthyl-C₁-C₂₀alkyl unsubstituted or substituted by one or more C₁-C₂₀alkyl, e.g. 1, 2 or 3 C₁-C₄alkyl, are 1-naphthylmethyl and 2-naphthylmethyl.

An example of naphthoxymethyl unsubstituted or substituted by one or more C₁-C₂₀alkyl, e.g. 1, 2 or 3 C₁-C₄alkyl, is 1-naphthoxymethyl.

An example of biphenylenyl, flourenyl or anthryl is 2-biphenylenyl, 9-flourenyl, 1-flourenyl or 9-anthryl, respectively.

Examples of a 5- to 6-membered heterocyclic radical unsubstituted or substituted by one or more C₁-C₂₀alky, e.g. 1, 2 or 3 C₁-C₄alkyl, are 3-pyridinyl, 4-pyridinyl, 2-hydroxypyridin-3-yl, 3-quinolinyl, 4-quinolinyl, 2-furyl, 3-furyl and 1-methyl-2-pyrryl.

Examples of a C₁-C₂₀hydrocarbon radical containing one or more halogen or pseudo-halogen, e.g. 1, 2, 3, 4, 5, or 6-F, —Cl or -J, are 1-bromo-2-methylpropyl, dichloromethyl, pentafluoroethyl, 3,5-bis[trifluoromethyl]phenyl, 2,3,5,6-tetrafluoro-p-tolyl, 2,3-dichlorophenyl, 3,4-dichlorophenyl and 2,4-bis[trifluoromethyl]phenyl.

An example of tri(C₁-C₁₀alkyl)silyl is (H₃C)₃Si—.

An example of tri(C₁-C₁₀alkyl)silyl(C₁-C₁₀alkyl) is (H₃C)₃Si—(CH₂)₂—.

Examples of a saturated or unsaturated aliphatic polyamine having 3 to 25 carbon atoms and y amino groups and optionally containing further hetero atom in its sceleton are 1,3-diaminopropane, 1,4-diaminobutane and 1,5-diaminopentane.

Examples of a saturated or unsaturated alicyclic polyamine having 6 to 25, preferably 6 to 13, carbon atoms and y amino groups and optionally containing further hetero atom in its sceleton are 1,2-diaminocyclohexane, 1,4-diaminocyclohexane, 4,4′-diaminodicyclohexyl, 4,4′-diamino-3,3′-dimethyldicyclohexyl, 4,4′-diaminodicyclohexylmethane, 4,4′-diamino-3,3′-dimethyldicyclohexylmethane, 1,3-bis(aminomethyl)cyclohexane, 1,4-bis(aminomethyl)cyclohexane, isophoronediamine, menthenediamine, melamine, 1,3,5-triaminocyclohexane, 1,2,4-triaminocyclohexane, 1,2,4,5-tetraminocyclohexane and the like.

Examples of an aromatic polyamine having 6 to 25, preferably 6 to 17, in particular 6 to 13, carbon atoms and y amino groups and optionally containing further hetero atoms in its sceleton are o-phenylenediamine, m-phenylenediamine, p-phenylenediamine, 2,3-diaminotoluene, 2,4-diaminotoluene, 2,6-diaminotoluene, 3,4-diaminotoluene, 4,6-dimethyl-m-phenylenediamine, 2,5-dimethyl-p-phenylenediamine, 4,5-dimethyl-o-phenylenediamine, 2,4-diaminomesitylene, 2,3-diaminopyridine, 2,6-diaminopyridine, 3,4-diaminopyridine, 1,5-diaminonaphthalene, 1,8-diaminonaphthalene, 2,3-diaminonaphthalene, 2,7-diaminonaphthalene, 9,10-diaminophenanthrene, 3,3′,5,5′-tetramethylbenzidine, 3,3′-dimethyl-4,4′-diaminobiphenyl, 3,3′-dimethoxy-4,4′-diaminobiphenyl, 4,4′-diaminodiphenylmethane, 3,3′-diaminodiphenylmethane, 3,4′-diaminodiphenylmethane, 4,4′-methylenedi-o-toluidine, 4,4′-methylenedi-2,6-xylidine, 4,4′-methylenedi-2,6-diethylaniline, 4,4′-diamino-1,2-diphenylethane, 4,4′-diamino-2,2′-dimethylbibenzyl, 4,4′-diaminostilbene, 3,4′-diamino-2,2-diphenylpropane, 4,4′-diamino-2,2-diphenylpropane, 4,4′-diaminodiphenylether, 3,4′-diaminodiphenylether, 4,4′-thiodianiline, 2,2′-dithiodianiline, 4,4′-dithiodianiline, 3,3′-diaminodiphenylsulfone, 4,4′-diaminodiphenylsulfone, 3,3′-diaminobenzophenone, 4,4′-diaminobenzophenone, 4,4′-diaminobenzanilide, o-tolidinesulfone, 2,7-diaminofluorene, 3,7-diamino-2-methoxyfluorene, bis-p-aminophenylaniline, 1,3-bis(4-aminophenylpropyl)benzene, 1,4-bis(4-aminophenylpropyl)benzene, 1,3-bis(4-aminophenoxy)benzene, 1,4-bis(4-aminophenoxy)benzene, 4,4′-bis(4-aminophenoxy)biphenyl, bis[4-(4-aminophenoxy)phenyl]ether, bis[4-(4-aminophenoxy)phenyl]sulfone, 9,9-bis(4-aminophenyl)fluorene-1,2,4,5-tetraminobenzene, 1,3,5-triaminobenzene, 1,2,4-triaminobenzene, Para Rosaniline, 2,4,6-triaminophenol, 3,3′-diaminobenzidine, tris(4-aminophenyl)methane, 2,4,6-triaminopyrimidine, and the like.

Examples of an unsaturated or saturated aliphatic amino carboxylic acid having 2 to 25, preferably 2 to 12, in particular 2 to 5, carbon atoms, z′ amino groups and z″ carboxyl groups and optionally containing further hetero atoms in its sceleton are aminoacetic acid, alpha-aminopropionic acid, beta-aminopropionic acid, alpha-aminoacrylic acid, alpha-aminobutyric acid, beta-aminobutyric acid, gamma-aminobutyric acid, alpha-amino-alpha-methylbutyric acid, gamma-amino-alpha-methylbutyric acid, alpha-aminoisobutyric acid, beta-aminoisobutyric acid, alpha-amino-n-valeric acid, delta-amino-n-valeric acid, beta-aminocrotonic acid, alpha-amino-beta-methylvaleric acid, alpha-aminoisovaleric acid, 2-amino-4-pentenoic acid, alpha-amino-n-caproic acid, 6-aminocaproic acid, alpha-aminoisocaproic acid, 7-aminoheptanoic acid, alpha-amino-n-caprylic acid, 8-aminocaprylic acid, 9-aminononanoic acid, 11-aminoundecanoic acid, 12-aminododecanoic acid, 2-aminoadipic acid, arginine, asparagine, aspartic acid, cystine, glutamic acid, glutamine, ornithine, creatine, S-(carboxymethyl)cystine, aminomalonic acid, and the like.

Examples of a saturated or unsaturated alicyclic amino carboxylic acid having 7 to 25, preferably 7 to 9, carbon atoms, z′ amino groups and z″ carboxyl groups and optionally containing further hetero atoms in its sceleton are 1-aminocyclohexanecarboxylic acid, 2-aminocyclohexanecarboxylic acid, 3-aminocyclohexanecarboxylic acid, 4-aminocyclohexanecarboxylic acid, p-aminomethylcyclohexanecarboxylic acid, 2-amino-2-norbornanecarboxylic acid, 3,5-diaminocyclohexanecarboxylic acid, 1-amino-1,3-cyclohexanedicarboxylic acid and the like.

Examples of an aromatic amino carboxylic acid having 7 to 25, preferably 7 to 15, in particular 7 to 11, carbon atoms, z′ amino groups and z″ carboxyl groups and optionally containing further hetero atoms in its sceleton are alpha-aminophenylacetic acid, alpha-amino-beta-phenylpropionic acid, 2-amino-2-phenylpropionic acid, 3-amino-3-phenylpropionic acid, alpha-amino cinnamic acid, 2-amino-4-phenylbutyric acid, 4-amino-3-phenylbutyric acid, anthranilic acid, m-aminobenzoic acid, p-aminobenzoic acid, 2-amino-4-methylbenzoic acid, 2-amino-6-methylbenzoic acid, 3-amino-4-methylbenzoic acid, 2-amino-3-methylbenzoic acid, 2-amino-5-methylbenzoic acid, 4-amino-2-methylbenzoic acid, 4-amino-3-methylbenzoic acid, 2-amino-3-methoxybenzoic acid, 3-amino-4-methoxybenzoic acid, 4-amino-2-methoxybenzoic acid, 4-amino-3-methoxybenzoic acid, 2-amino-4,5-dimethoxybenzoic acid, o-aminophenylacetic acid, m-aminophenylacetic acid, p-aminophenylacetic acid, 4-(4-aminophenyl)butyric acid, 4-aminomethylbenzoic acid, 4-aminomethylphenylacetic acid, o-aminocinnamic acid, m-aminocinnamic acid, p-aminocinnamic acid, p-aminohippuric acid, 2-amino-1-naphthoic acid, 3-amino-1-naphthoic acid, 4-amino-1-naphthoic acid, 5-amino-1-naphthoic acid, 6-amino-1-naphthoic acid, 7-amino-1-naphthoic acid, 8-amino-1-naphthoic acid, 1-amino-2-naphthoic acid, 3-amino-2-naphthoic acid, 4-amino-2-naphthoic acid, 5-amino-2-naphthoic acid, 6-amino-2-naphthoic acid, 7-amino-2-naphthoic acid, 8-amino-2-naphthoic acid, 3,5-diaminobenzoic acid, 4,4′-diamino-3,3′-dicarboxydiphenylmethane and the like.

Examples of halogen or pseudo-halogen are —F, —Cl, —Br, -J, —CN, —CNO, —OCN, —SCN and —CNS.

An example of the formula (ID) wherein 2 radicals R form together with 2 adjacent carbon atoms of the unsaturated parent ring a 5- to 7-membered carbocyclic or heterocyclic ring is

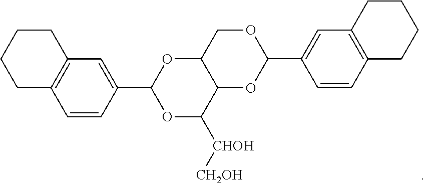

The additive used according to the present invention is preferably a compound of the formula (IA), (IB) or (10), x, y or the sum of z′ and z″ are 2 or 3, and when x, y or the sum of z′ and z″ are 2, X₀, Y₀, and Z₀ are the group of the formula

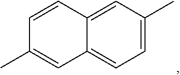

and

when x, y or the sum of z′ and z″ are 3, X₀, Y₀, and Z₀ are the group of the formula

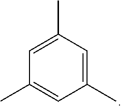

The additive used according to the present invention is in particular a compound of the formula (IA), (IB) or (IC),

the radicals X₁, Y₁, Z₁ and Z₂ independently of one another are

C₁-C₁₀alkyl unsubstituted or substituted by 1, 2 or 3 hydroxy, amino and/or nitro;

C₂-C₂₀alkenyl unsubstituted or substituted by 1, 2 or 3 hydroxy, amino and/or nitro;

C₂-C₁₀alkyl interrupted by oxygen;

C₃-C₆cycloalkyl unsubstituted or substituted by 1, 2, 3 or 4 C₁-C₄alkyl;

(C₃-C₆cycloalkyl)-C₁-C₁₀alkyl unsubstituted or substituted by 1, 2 or 3 C₁-C₄alkyl;

bis[C₃-C₆cycloalkyl]-C₁-C₁₀alkyl unsubstituted or substituted by 1, 2 or 3 C₁-C₄alkyl;

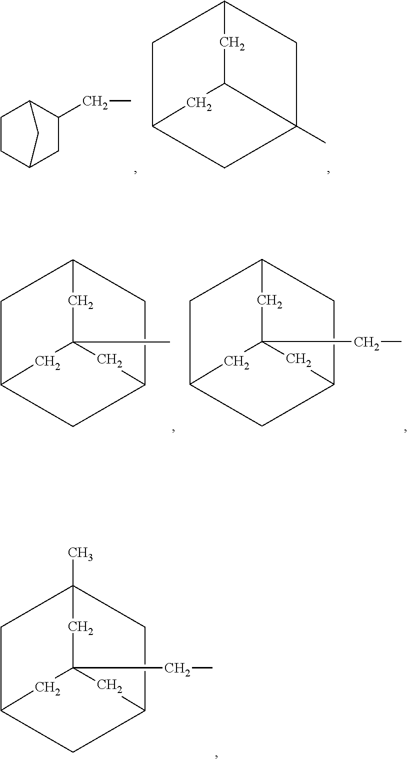

phenyl unsubstituted or substituted by 1, 2 or 3 radicals selected from C₁-C₄alkyl, C₁-C₄alkoxy, C₁-C₄alkylamino, di(C₁-C₄alkyl)amino, amino, hydroxy and nitro;

phenyl-C₁-C₁₀alkyl unsubstituted or substituted by 1, 2 or 3 radicals selected from C₁-C₄alkyl, C₃-C₆cycloalkyl, phenyl, C₁-C₄alkoxy, hydroxy, amino and nitro;

phenylethenyl unsubstituted or substituted by 1, 2 or 3 C₁-C₄alkyl;

biphenyl-(C₁-C₁₀alkyl) unsubstituted or substituted by 1, 2 or 3 C₁-C₄alkyl;

naphthyl unsubstituted or substituted by 1, 2 or 3 C₁-C₄alkyl;

naphthyl-C₁-C₁₀alkyl unsubstituted or substituted by 1, 2 or 3 C₁-C₄alkyl;

naphthoxymethyl unsubstituted or substituted by 1, 2 or 3 C₁-C₄alkyl;

biphenylenyl, flourenyl, anthryl;

3-pyridinyl, 4-pyridinyl, 2-hydroxypyridin-3-yl, 3-quinolinyl, 4-quinolinyl, 2-furyl, 3-furyl, 1-methyl-2-pyrryl;

1-bromo-2-methylpropyl, dichloromethyl, pentafluoroethyl, 3,5-bis[trifluoromethyl]phenyl, 2,3,5,6-tetrafluoro-p-tolyl, 2,3-dichlorophenyl, 3,4-dichlorophenyl or 2,4-bis[trifluoromethyl]phenyl;

tri(C₁-C₁₀alkyl)silyl; or

tri(C₁-C₁₀alkyl)silyl(C₁-C₁₀alkyl).

Preferred is also a compound of the formula (IA), (IB) or (IC) wherein

the radicals X₁, Y₁, Z₁ and Z₂ independently of one another are

branched C₃-C₁₀alkyl;

C₃-C₁₀alkyl interrupted by oxygen;

C₃-C₆cycloalkyl unsubstituted or substituted by 1, 2, 3 or 4 C₁-C₄alkyl;

(C₃-C₆cycloalkyl)-C₁-C₁₀alkyl unsubstituted or substituted by 1, 2 or 3 C₁-C₄alkyl;

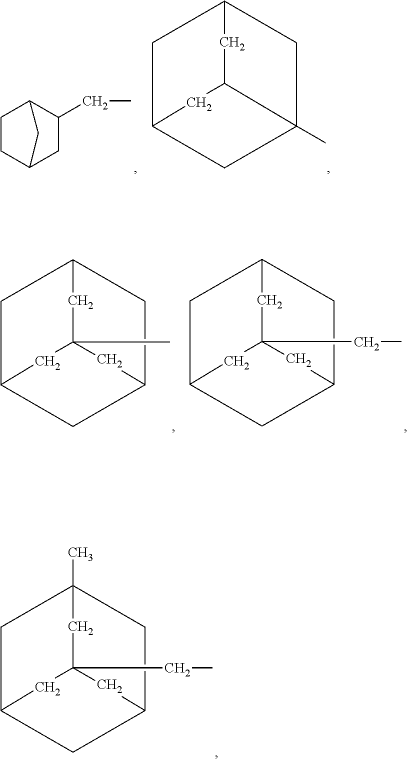

phenyl unsubstituted or substituted by 1, 2 or 3 C₁-C₄alkyl;

phenyl-C₁-C₁₀alkyl unsubstituted or substituted by 1, 2 or 3 radicals selected from C₁-C₄alkyl and C₁-C₄alkoxy;

biphenyl-(C₁-C₁₀alkyl);

naphthyl-C₁-C₁₀alkyl;

tri(C₁-C₁₀alkyl)silyl; or

tri(C₁-C₄alkyl)silyl(C₁-C₆alkyl).

Further preferred is a compound of the formula (IA) wherein

x is 2 or 3,

when x is 2, X₀ is the group of the formula

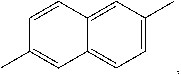

and

when x is 3, X₀ is the group of the formula

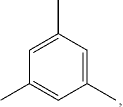

and

the radicals X₁ independently of one another are 1,1-dimethylethyl, 1-methylpropyl, 2-methylpropyl, 1,1-dimethylpropyl, 1,2-dimethylpropyl, 2,2-dimethylpropyl, 1-ethylpropyl, 1-methylbutyl, 2-methylbutyl, 3-methylbutyl, 1,1,3,3-tetramethylbutyl, cyclohexyl, 2-methylcyclohexyl, 3-methylcyclohexyl or 2,3-dimethylcyclohexyl.

Particular preferred is a compound of the formula (IB) wherein

y is 2 or 3,

when y is 2, Y₀ is the group of the formula

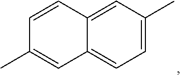

and

when y is 3, Y₀ is the group of the formula

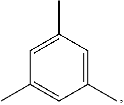

and

the radicals Y₁ independently of one another are 1,1-dimethylethyl, 1-methylpropyl, 2-methylpropyl, 1,1-dimethylpropyl, 1,2-dimethylpropyl, 2,2-dimethylpropyl, 1-ethylpropyl, 1-methylbutyl, 2-methylbutyl, 3-methylbutyl, 1,1,3,3-tetramethylbutyl, cyclohexyl, 2-methylcyclohexyl, 3-methylcyclohexyl or 2,3-dimethylcyclohexyl.

Of interest is also a compound of the formula (IC) wherein

z′ and z″ independently of one are another 1 or 2, and

when the sum of z′ and z″ is 2, Z₀ is the group of the formula

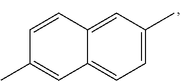

and

when the sum of z′ and z″ is 3, Z₀ is the group of the formula

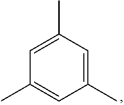

and

the radicals Z₁ and Z₂ independently of one another are 1,1-dimethylethyl, 1-methylpropyl, 2-methylpropyl, 1,1-dimethylpropyl, 1,2-dimethylpropyl, 2,2-dimethylpropyl, 1-ethylpropyl, 1-methylbutyl, 2-methylbutyl, 3-methylbutyl, 1,1,3,3-tetramethylbutyl, cyclohexyl, 2-methylcyclohexyl, 3-methylcyclohexyl or 2,3-dimethylcyclohexyl.

A particular preferred compound of the formula (IA) is

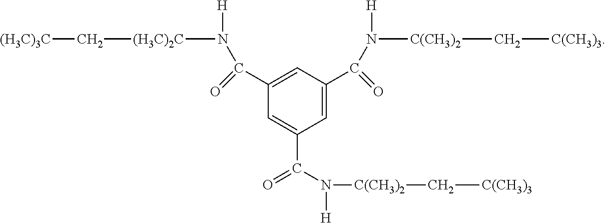

Preferred examples of compounds of the formulae (IB) and (IC) are disclosed in the working examples and claim 43 of WO-A-2004/072,168 which is incorporated by reference herein.

Preferred examples of compounds of the formula (ID) are
1,3:2,4-di(benzylidene) sorbitol (e.g. commercially available as IRGACLEAR D®),
1,3:2,4-di-(4-ethylbenzylidene) sorbitol,
1,3:2,4-di-(4-methylbenzylidene) sorbitol (e.g. commercially available as IRGACLEAR DM®),
1,3:2,4-di-(3-methylbenzylidene) sorbitol and
1,3:2,4-di-(3,4-dimethylbenzylidene) sorbitol (e.g. commercially available as MILLAD 3988®).

The additives suitable for the process according to the present invention are known and can be prepared in analogy to known methods, for example, the compounds of the formulae (IA), (IB), (IC) and (ID) can be prepared in analogy to the methods described in U.S. Pat. No. 5,973,076, US-A-2004/0,063,830, WO-A-2004/072,168, U.S. Pat. No. 5,023,354 and U.S. Pat. No. 5,198,484.

The additive with a needle-like morphology in its solid state is preferably present in the polymer melt in an amount of 0.01% to 0.25% by weight, relative to the weight of the thermoplastic polymer.

The additive used according to the present invention may be incorporated into the thermoplastic polymer by commonly used industrial techniques prior to or during melt processing. The additive can be applied in pure form or in mixtures with other commonly used additives. It can also be added in the form of a solid powder blend with polymer fluff, as a concentrate or masterbatch or as a liquid preparation in form of a melt, solution or dispersion in suitable carrier materials.

Examples of a suitable thermoplastic polymer are:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethyllene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polyketones.

21. Polysulfones, polyether sulfones and polyether ketones.

22. Unsaturated polyester resins derived from copolyesters of saturated and unsaturated dicarboxylic acids with polyhydric alcohols and vinyl compounds as crosslinking agents, and also halogen-containing modifications thereof of low flammability.

23. Crosslinkable acrylic resins derived from substituted acrylates, for example epoxy acrylates, urethane acrylates or polyester acrylates.

24. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

25. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

Polyolefins, in particular those listed above under item 1 are preferred.

Polypropylene, polyethylene, any polypropylene copolymer or any polyethylene copolymer or any of their blends is particularly preferred.

The process according to the present invention is advantageous for any type of melt processing of thermoplastic polymers, where high shear conditions and high flow rates are applied for the manufacture of shaped articles. The process is in particular advantageous for extrusion methods, e.g. for the manufacture of thin-walled profiles, cast and blown films, profiles, sheets, wires and cables and the like.

Thus, a further preferred embodiment of the present invention relates to a process as defined above, applied for the purpose of preventing melt fracture during processing of a melt containing a thermoplastic polymer, in particular for the manufacture of thin-walled profiles, cast or blown films, sheets, wires or cables.

The polymer melt may optionally contain one or more conventional additives commonly used in the plastics' industry. Suitable examples are:

1. Antioxidants

1.1. Alkylated Monophenols,

for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1-methylheptadec-1′-yl)phenol, 2,4-dimethyl-6-(1′-methyltridec-1-yl)phenol and mixtures thereof.

1.2. Alkylthiomethylphenols,

for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and Alkylated Hydroquinones,

for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroq uinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols,

for example α-tocopherol, β-tocopherol, γ-tocopherol, δ-tocopherol and mixtures thereof (vitamin E).

1.5. Hydroxylated Thiodiphenyl Ethers,

for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.

1.6. Alkylidenebisphenols,

for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methyllenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.

1.7. O-, N- and S-benzyl Compounds,

for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated Malonates,

for example dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic Hydroxybenzyl Compounds,

for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine Compounds,

for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylohosohonates,

for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols,

for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid

with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethyllene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid

with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of β-(3,5-dicyclohexyl-4-hydroxyphenyl)propionic acid

with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid

with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid

e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

1.18. Ascorbic Acid (Vitamin C)

1.19. Aminic Antioxidants,

for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

2. UV Absorbers and Light Stabilizers

2.1. 2-(2′-Hydroxyphenyl)benzotriazoles,

for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CHCOO—CH₂CH₂₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole; 2-[2′-hydroxy-3′-(1,1,3,3-tetramethylbutyl)-5′-(α,α-dimethylbenzyl)-phenyl]benzotriazole.

2.2. 2-Hydroxybenzophenones,

for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of Substituted and Unsubstituted Benzoic Acids,

for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates,

for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-di-phenylacrylate.

2.5. Nickel Compounds,

for example nickel complexes of 2,2′-thio-bis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically Hindered Amines,

for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydrooxy-2-methylpropoxy)-4-octadecanoyloxy-2,2,6,6-tetramethylpiperidine, 5-(2-ethylhexanoyl)-oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis-[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)-amino)-s-triazine.

2.7. Oxamides,

for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines,

for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydrooxy-4-methoxyphenyl)-4,6-d iphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.

3. Metal Deactivators,

for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and Phosphonites,

for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl) phosphite (Irgafos 168, Ciba Specialty Chemicals Inc.), tris(nonylphenyl) phosphite,

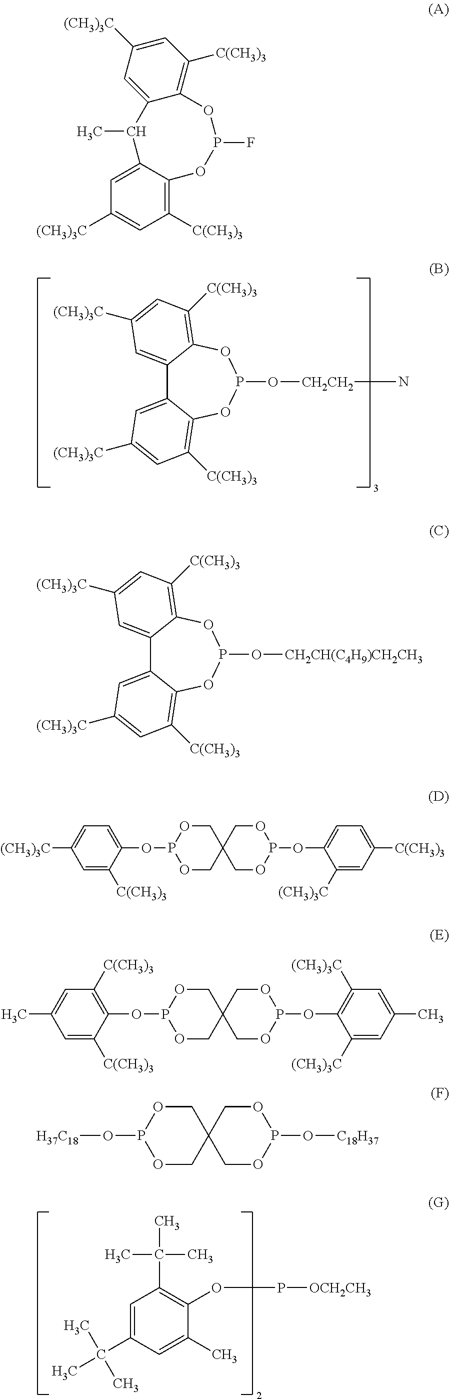

5. Hydroxylamines,

for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones,

for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

7. Thiosvnergists,

for example dilauryl thiodipropionate, dimistryl thiodipropionate, distearyl thiodipropionate or distearyl disulfide.

8. Peroxide Scavengers,

for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

9. Polyamide Stabilizers,

for example copper salts in combination with iodides and/or phosphorus compounds and salts of divalent manganese.

10. Basic Co-Stabilizers,

for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating Agents,

for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzyl idene)sorbitol, and 1,3:2,4-di(benzylidene)sorbitol.

12. Fillers and Reinforcing Agents,

for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.

13. Other Additives,

for example plasticisers, lubricants, emulsifiers, pigments, rheology additives, catalysts, flow-control agents, optical brighteners, flameproofing agents, antistatic agents and blowing agents.

14. Benzofuranones and Indolinones,

for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-di-methylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

The conventional additive is for example present in the polymer melt in an amount of 0.001 to 10% by weight, preferably 0.001 to 5% by weight, relative to the weight of the thermoplastic polymer. Conventional fillers or reinforcing agents may be present in the polymer melt in amounts of 0.1 to 10% by weight, preferably 1 to 5% by weight, in certain cases in amounts up to 70% by weight, relative to the weight of the thermoplastic polymer.

A further embodiment of the present invention relates to the use of a compound of the formula (IA), (IB), (IC) or (ID) to improve the flow properties of a melt containing a thermoplastic polymer.

Still another embodiment of the present invention relates to the use of a compound of the formula (IA), (IB), (IC) or (ID) as processing aid for a thermoplastic polymer.

The following examples describe the present invention in more detail. All parts and percentages are given by weight unless indicated otherwise.

Additives Used:

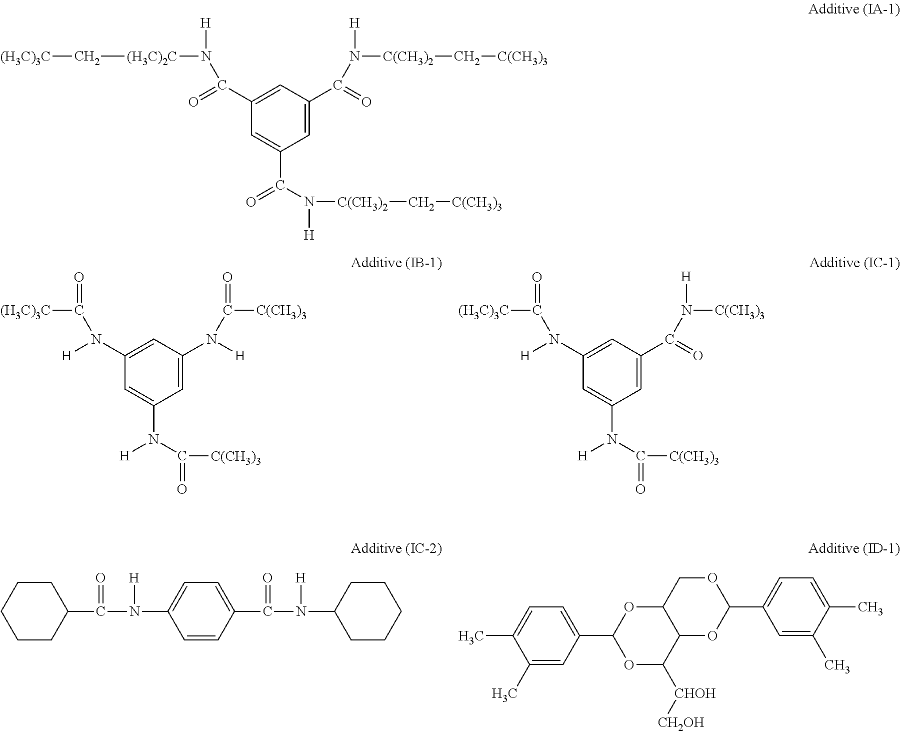

### Example 1

99.9% of Exxon Mobil® LL 1201 XV linear low density polyethylene (LLDPE) powder and 0.1% of Additive (IA-1) are intimately mixed in a Henschel® high speed mixer for 2 min. The formulations are then compounded on a Theysohn® TSK 30/44 twin screw extruder at 230° C. For reference, also samples without the Additive (IA-1) are prepared.

A) The rheological properties of the pellets are subsequently tested at 170° C. using a bypass viscosimeter of Göttfert®. The results are listed below.

Polymer Sample without the Additive (IA-1):

Melt fracture is observed at shear rates of 68 sec⁻¹ or more; visible as whitening of the melt during extrusion and eventually reflected as rough surface of the polymer extrudate, e.g. a strand after cooling.

Polymer Sample Containing the Additive (IA-1):

No melt fracture is observed at higher shear rates than 68 sec⁻¹. Even under more drastic conditions up to 124 sec⁻¹, the phenomena of above like melt whitening or surface roughness is not detected.

B) The polymer samples show the following crystallization peak temperature during cooling (DSC results obtained after sample heating to 240° C. at constant heating and subsequent cooling rate of 10° C./min; all tests run under nitrogen):

Polymer Sample without the Additive (IA-1):

Crystallization at T_{C}=108.0° C.

Polymer Sample Containing the Additive (IA-1):

Crystallization at T_{C}=110.2° C.

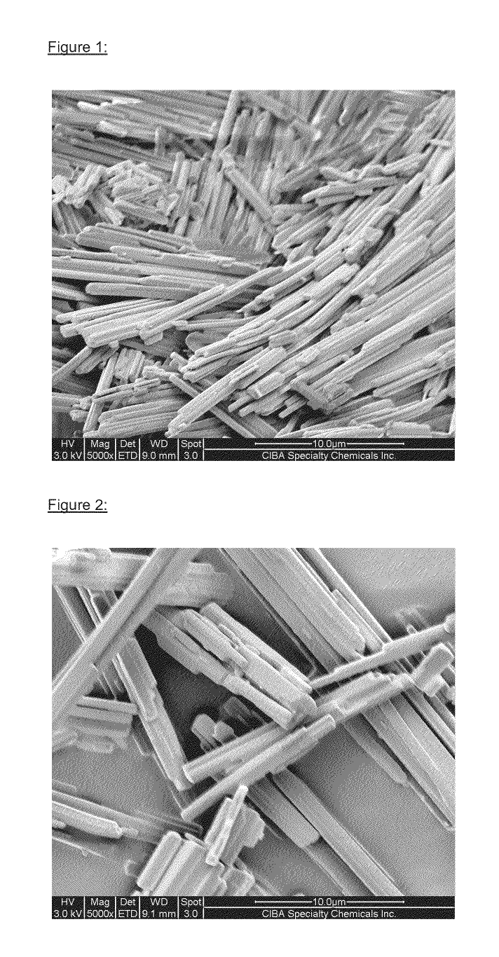

The needle-like morphology of the Additive (IA-1) is shown in FIG. 1.

C) FIG. 1 is obtained from scanning electron microscopy (SEM). Additive (IA-1) has been used for the SEM studies in its pure form; i.e. in the form as obtained after synthesis without additional grinding, blending with other additive components or the like.

Additive (IA-1) exhibits the columnar structures shown in FIG. 1 which allows the determination of the values for the length/diameter ratios of the primary columnar particles.

The sample preparation for the SEM studies is carried-out by conventional methods: Some micro-grams of the additive are positioned on a sampler holder inside the vacuum chamber of a commercial SEM device, and scanning is subsequently performed according to common practice and operation manuals. Magnification is adjusted to sensible ranges so that the lenth/diameter ratios can be easily determined.

As can be seen from FIG. 1, the columnar structure of Additive (IA-1) has an average length/diameter ratio in the range of 20/1 to 80/1.

### Example 2

The length/diameter ratio of the needle-like morphology of the Additive (IB-1) is determined in analogy to Example 10.

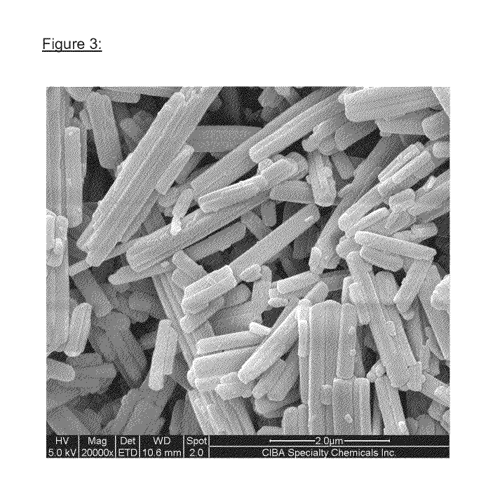

The needle-like morphology of the Additive (IB-1) is shown in FIG. 2.

As can be seen from FIG. 2, the columnar structure of Additive (IB-1) has an average length/diameter ratio in the range of 12/1 to 50/1.

### Example 3

The length/diameter ratio of the needle-like morphology of the Additive (ID-1) is determined in analogy to Example 10.

The needle-like morphology of the Additive (ID-1) is shown in FIG. 3.

As can be seen from FIG. 3, the columnar structure of Additive (ID-1) has an average length/diameter ratio in the range of 8/1 to 30/1.

### Example 4

Preparations of further samples containing the Additive (IA-1) and reference samples without additive as well as the measurements described in EXAMPLE 1 are repeated, but using the commercial linear low density polyethylene (LLDPE) type Dowlex 2045® instead of the Exxonmobil LL 1201 XV®.

Without additive, the onset of melt fracture is observed at a shear rate of 48 s⁻¹. In presence of 0.1% of the Additive (IA-1), the LLDPE does not show melt fracture up to 120 s⁻¹ shear rate.

### Example 5

EXAMPLE 4 with Dowlex 2045® is repeated, but replacing the Additive (IA-1) with 0.1% of the Additive (IB-1). Like in the previous case, no melt fracture is observed up to a shear rate of 120 s⁻¹, if the Additive (IB-1) is present.

### Example 6

Correspondingly, replacing Additive (IA-1) in EXAMPLE 4 with 0.1% of the Additve (IC-1), no melt fracture is observed up to a shear rate of 120 s⁻¹.

Thus, the efficiency of the Additives (IA-1), (IB-1) and (IC-1) as melt fracture suppressants is found to be the more or less the same in those cases of above.

### Examples 7 to 13

The following examples are intended to illustrate the usefulness of the invention for different types of linear low density polyethylene (LLDPE). Formulations No. 7 to 13 below are prepared as described in the previous EXAMPLE 1. The pelletized and homogeneous samples obtained in this way are subsequently processed at 200° C. on a 30 mm single screw extruder from Göttfert®. The polymer melt is extruded through a one-hole die with a diameter as listed; the strand obtained is eventually cooled to ambient temperature and carefully analyzed.

In order to evaluate the formulations, the extruder throughput—proportional to the revolutions of the extruder screw—is slowly and continuously increased form 1 rpm to 100 rpm. The onset of melt fracture becomes clearly visible as shark-skin-like defects on the strand surface, when a certain throughput is reached. The individual values for this maximal screw speed (rpm)* and correspondingly, the “maximal shear rates without melt fracture” are listed in Table 1.

TABLE 1

| | Linear Low | Diameter | Inventive | Screw | Shear |
|---|---|---|---|---|---|
| Ex. | Density | of Die | Additive(s) | Rotation | Rate |
| No. | Polyethylene | (mm) | (0.1%) | (rpm) * | (s⁻¹) # |
| 7 | Exxonmobil LL | 3.0 | IA-1 | 23 | 236 |
| | 1201 XV (RTM) | | | | |
| 8 | Exxonmobil LL | 3.0 | IA-1 | 33 | 339 |
| | 1001 (RTM) | | | | |
| 9 | Exxonmobil LL | 3.0 | IA-1 | 33 | 339 |
| | 1002 (RTM) | | | | |
| 10 | Finacene EF | 3.0 | IA-1 | 33 | 339 |
| | 2245 (RTM) | | | | |
| 11 | Exxonmobil LL | 2.0 | IC-2 | 5 | 173 |
| | 1201 XV (RTM) | | | | |
| 12 | Borocene FL | 3.0 | IA-1 | 10 | 101 |
| | 5270 (RTM) | | | | |
| 13 | Exxonmobil LL | 3.0 | IA-2 | 23 | 236 |
| | 1201 XV (RTM) | | | | |

(rpm) * revolutions per minute of the extruder screw, when first signs of melt fracture are observed as so-called shark-skin; no melt fracture at lower rpm.
(s⁻¹) #: maximal shear rates possible, before melt fracture occurs.

Additive (IA-2)

is a formulation with 0.1% of Additive (IA-1), but containing additionally 0.1% glycerol mono-stearate (Atmer-129®) and 0.01% Vitamin E (Irganox E-201®), the latter two components improving the overall dispersion behaviour. This positive side effect does not influence the maximal shear rates obtained, but simplifies the incorporation of the additives, so that a homogeneous distribution in the polymer matrix is faster and easier achieved.

Table 2 of below reports the reference values of the LLDPE types for the onset of melt fracture, when no additives of the present invention are used. As can be seen from these data, certain differences in the maximal screw rotation (corresponding to maximal throughput) and maximal shear rates are observed depending on the properties of the polymer used. By comparison versus the corresponding formulations of Table 1, the effects of the additives according to the invention become very obvious. Melt fracture is observed only at much higher shear rates in case of each inventive formulation of Examples 7 through 13 in Table 1 versus the corresponding Examples 7 (comp) through 13 (comp) given in Table 2.

TABLE 2
Comparative Formulations of LLDPE
without Inventive Additive(s)

| Comparison | | Diameter | Screw | Shear |
|---|---|---|---|---|
| versus | Linear Low density | of Die | Rotation | Rate |
| Example No. | Polyethylene | (mm) | (rpm) * | (s⁻¹) |
| 7 (comp) | Exxonmobil LL 1201 XV | 3.0 | 5.0 | 51 |
| | (RTM) | | | |
| 8 (comp) | Exxonmobil LL 1001 | 3.0 | 7.5 | 77 |
| | (RTM) | | | |
| 9 (comp) | Exxonmobil LL 1002 | 3.0 | 15 | 154 |
| | (RTM) | | | |
| 10 (comp) | Finacene EF 2245 (RTM) | 3.0 | 7.5 | 77 |
| 11 (comp) | Exxonmobil LL 1201 XV | 2.0 | 2.0 | 69 |
| | (RTM) | | | |
| 12 (comp) | Borocene FL 5270 (RTM) | 3.0 | 3.3 | 34 |
| 13 (comp) | Exxonmobil LL 1201 XV | 3.0 | 5.0 | 51 |
| | (RTM) | | | |

1. A process for improving the flow properties of a melt containing a thermoplastic polymer, which comprises incorporating 0.005% to 0.5% by weight, relative to the weight of the thermoplastic polymer, of one or more additives selected from the group consisting of organic and inorganic compounds with needle-like morphology in their solid state into said thermoplastic polymer prior to or during melt processing.

2. A process according to claim 1, wherein the additive is an organic compound with needle-like morphology in its solid state.

3. A process according to claim 1, wherein the needle-like morphology of the pure additive in its solid state is a columnar structure exhibiting an average length/diameter ratio of more than 3.

4. A process according to claim 1, wherein the additive has a melting point which is at least 30° C. higher than the melting point of the thermoplastic polymer.

5. A process according to claim 1, wherein the additive enhances the crystallization peak temperature T_{c} of the thermoplastic polymer by at least 1° C.

6. A process according to claim 1, wherein the additive is an organic compound containing polar moieties enabled to undergo long-range polar-polar interaction by hydrogen bonding.

7. A process according to claim 1, wherein the additive is an organic compound containing polar moieties and shielding non-polar hydrophobic groups on the outer molecular sphere.

8. A process according to claim 1, wherein the additive is an organic compound containing one or more —OH or >NH groups.

9. A process according to claim 1, wherein the additive is a compound of the formula (IA), (IB), (IC) or (ID) 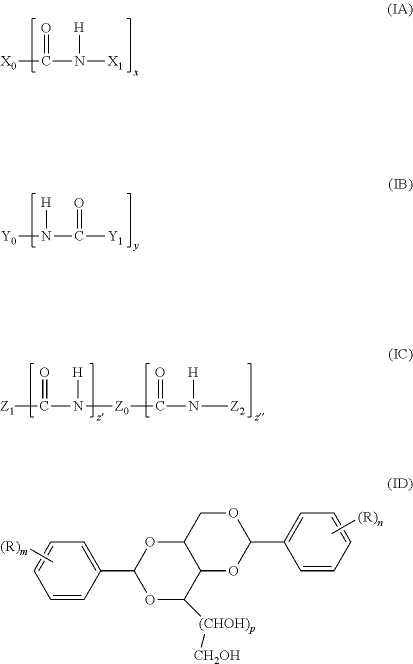
wherein
x and y are an integer from 2 to 6;
z′ and z″ independently of one another are an integer from 1 to 5 with the proviso that the sum of z′ and z″ is an integer from 2 to 6;
p is zero or 1;
m and n independently of one another are an integer from zero to 3;
X₀ is a residue which is formed by elimination of x carboxyl groups of a saturated or unsaturated aliphatic polycarboxylic acid having 3 to 25 carbon atoms,
a residue which is formed by elimination of x carboxyl groups of a saturated or unsaturated alicyclic polycarboxylic acid having 7 to 25 carbon atoms or
a residue which is formed by elimination of x carboxyl groups of an aromatic polycarboxylic acid having 8 to 25 carbon atoms; any of said polycarboxylic acids optionally contains further hetero atoms in its skeleton;
the radicals X₁ independently of one another are
C₁-C₂₀alkyl unsubstituted or substituted by one or more hydroxy, amino and/or nitro groups;
C₂-C₂₀alkenyl unsubstituted or substituted by one or more hydroxy, amino and/or nitro groups;
C₂-C₂₀alkyl interrupted by oxygen or sulfur;
C₃-C₁₂cycloalkyl unsubstituted or substituted by one or more C₁-C₂₀alkyl;
(C₃-C₁₂cycloalkyl)-C₁-C₁₀alkyl unsubstituted or substituted by one or more C₁-C₂₀alkyl;
bis[C₃-C₁₂cycloalkyl]-C₁-C₁₀alkyl unsubstituted or substituted by one or more C₁-C₂₀alkyl;
a bicyclic or tricyclic hydrocarbon radical with 5 to 20 carbon atoms unsubstituted or substituted by one or more C₁-C₂₀alkyl;
phenyl unsubstituted or substituted by one or more radicals selected from C₁-C₂₀alkyl, C₁-C₂₀alkoxy, C₁-C₂₀alkylamino, di(C₁-C₂₀alkyl)amino, amino, hydroxy and nitro;
phenyl-C₁-C₂₀alkyl unsubstituted or substituted by one or more radicals selected from C₁-C₂₀alkyl, C₃-C₁₂cycloalkyl, phenyl, C₁-C₂₀alkoxy, amino, hydroxy and nitro;
phenylethenyl unsubstituted or substituted by one or more C₁-C₂₀alkyl;
biphenyl-(C₁-C₁₀alkyl) unsubstituted or substituted by one or more C₁-C₂₀alkyl;
naphthyl unsubstituted or substituted by one or more C₁-C₂₀alkyl;
naphthyl-C₁-C₂₀alkyl unsubstituted or substituted by one or more C₁-C₂₀alkyl;
naphthoxymethyl unsubstituted or substituted by one or more C₁-C₂₀alkyl;
biphenylenyl, flourenyl, anthryl;
a 5- to 6-membered heterocyclic radical unsubstituted or substituted by one or more C₁-C₂₀alkyl;
a C₁-C₂₀hydrocarbon radical containing one or more halogen or pseudo-halogen;
tri(C₁-C₁₀alkyl)silyl; or
tri(C₁-C₁₀alkyl)silyl(C₁-C₁₀alkyl);
Y₀ is a residue which is formed by elimination of y amino groups of a saturated or unsaturated aliphatic polyamine having 3 to 25 carbon atoms,
a residue which is formed by elimination of y amino groups of a saturated or unsaturated alicyclic polyamine having 6 to 25 carbon atoms or
a residue which is formed by elimination of y amino groups of an aromatic polyamine having 6 to 25 carbon atoms; any of said polyamines optionally contains further hetero atoms in its skeleton;
the radicals Y₁ independently of one another have one of the definitions of X₁;
Z₀ is a residue which is formed by elimination of z′ amino groups and z″ carboxyl groups of an unsaturated or saturated aliphatic amino carboxylic acid having 2 to 25 carbon atoms,
a residue which is formed by elimination of z′ amino groups and z″ carboxyl groups of a saturated or unsaturated alicyclic amino carboxylic acid having 7 to 25 carbon atoms or
a residue which is formed by elimination of z′ amino groups and z″ carboxyl groups of an aromatic amino carboxylic acid having 7 to 25 carbon atoms; any of said amino carboxylic acids optionally contains further hetero atoms in its skeleton;
the radicals Z₁ and Z₂ independently of one another have one of the definitions given for X₁; and
the radicals R independently of one another are C₁-C₈alkyl, C₁-C₈alkoxy, hydroxy, halogen, pseudo-halogen, C₁-C₈alkylthio, C₁-C₈alkylsulfoxy or 2 radicals R form together with 2 adjacent carbon atoms of the unsaturated parent ring a 5- to 7-membered carbocyclic or heterocyclic ring.

10. A process according to claim 9, wherein the additive is a compound of the formula (IA), (IB) or (IC),
x, y or the sum of z′ and z″ are 2 or 3, and
when x, y or the sum of z′ and z″ are 2, X₀, Y₀, and Z₀ are the group of the formula 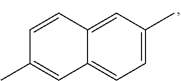
and
when x, y or the sum of z′ and z″ are 3, X₀, Y₀, and Z₀ are the group of the formula

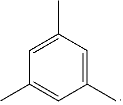

11. A process according to claim 9 wherein the additive is a compound of the formula (IA), (IB) or (IC),
the radicals X₁, Y₁, Z₁ and Z₂ independently of one another are
C₁-C₁₀alkyl unsubstituted or substituted by 1, 2 or 3 hydroxy, amino and/or nitro;
C₂-C₂₀alkenyl unsubstituted or substituted by 1, 2 or 3 hydroxy, amino and/or nitro;
C₂-C₁₀alkyl interrupted by oxygen;
C₃-C₆cycloalkyl unsubstituted or substituted by 1, 2, 3 or 4 C₁-C₄alkyl;
(C₃-C₆cycloalkyl)-C₁-C₁₀alkyl unsubstituted or substituted by 1, 2 or 3 C₁-C₄alkyl;
bis[C₃-C₆cycloalkyl]-C₁-C₁₀alkyl unsubstituted or substituted by 1, 2 or 3 C₁-C₄alkyl; 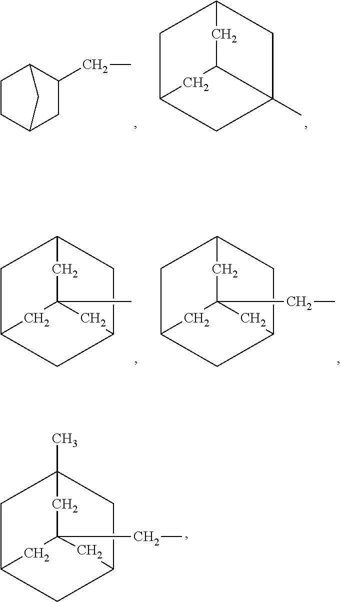
phenyl unsubstituted or substituted by 1, 2 or 3 radicals selected from C₁-C₄alkyl, C₁-C₄alkoxy, C₁-C₄alkylamino, di(C₁-C₄alkyl)amino, amino, hydroxy and nitro;
phenyl-C₁-C₁₀alkyl unsubstituted or substituted by 1, 2 or 3 radicals selected from C₁-C₄alkyl, C₃-C₆cycloalkyl, phenyl, C₁-C₄alkoxy, hydroxy, amino and nitro;
phenylethenyl unsubstituted or substituted by 1, 2 or 3 C₁-C₄alkyl;
biphenyl-(C₁-C₁₀alkyl) unsubstituted or substituted by 1, 2 or 3 C₁-C₄alkyl;
naphthyl unsubstituted or substituted by 1, 2 or 3 C₁-C₄alkyl;
naphthyl-C₁-C₁₀alkyl unsubstituted or substituted by 1, 2 or 3 C₁-C₄alkyl;
naphthoxymethyl unsubstituted or substituted by 1, 2 or 3 C₁-C₄alkyl;
biphenylenyl, flourenyl, anthryl; 3-pyridinyl, 4-pyridinyl, 2-hydroxypyridin-3-yl, 3-quinolinyl, 4-quinolinyl, 2-furyl, 3-furyl, 1-methyl-2-pyrryl;
1-bromo-2-methylpropyl, dichloromethyl, pentafluoroethyl, 3,5-bis[trifluoromethyl]phenyl, 2,3,5,6-tetrafluoro-p-tolyl, 2,3-dichlorophenyl, 3,4-dichlorophenyl or 2,4-bis[trifluoromethyl]phenyl;
tri(C₁-C₁₀alkyl)silyl; or
tri(C₁-C₁₀alkyl)silyl(C₁-C₁₀alkyl).

12. A process according to claim 9 wherein the additive is a compound of the formula (IA), (IB) or (IC),
the radicals X₁, Y₁, Z₁ and Z₂ independently of one another are
branched C₃-C₁₀alkyl;
C₃-C₁₀alkyl interrupted by oxygen;
C₃-C₆cycloalkyl unsubstituted or substituted by 1, 2, 3 or 4 C₁-C₄alkyl;
(C₃-C₆cycloalkyl)-C₁-C₁₀alkyl unsubstituted or substituted by 1, 2 or 3 C₁-C₄alkyl; 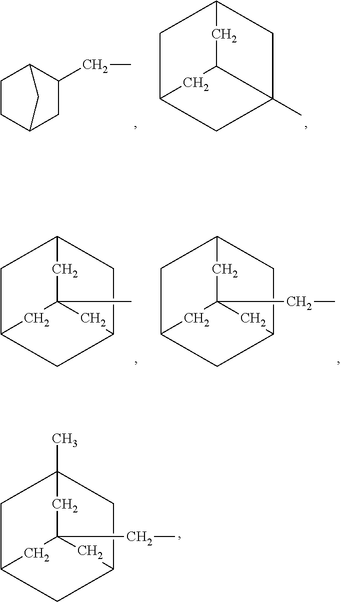
phenyl unsubstituted or substituted by 1, 2 or 3 C₁-C₄alkyl;
phenyl-C₁-C₁₀alkyl unsubstituted or substituted by 1, 2 or 3 radicals selected from C₁-C₄alkyl and C₁-C₄alkoxy;
biphenyl-(C₁-C₁₀alkyl);
naphthyl-C₁-C₁₀alkyl;
tri(C₁-C₁₀alkyl)silyl; or
tri(C₁-C₄alkyl)silyl(C₁-C₆alkyl).

13. A process according to claim 9, wherein the additive is a compound of the formula (IA),
x is 2 or 3,
when x is 2, X₀ is the group of the formula 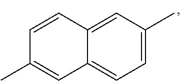
and
when x is 3, X₀ is the group of the formula 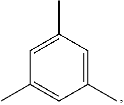
and
the radicals X₁ independently of one another are 1,1-dimethylethyl, 1-methylpropyl, 2-methylpropyl, 1,1-dimethylpropyl, 1,2-dimethylpropyl, 2,2-dimethylpropyl, 1-ethylpropyl, 1-methylbutyl, 2-methylbutyl, 3-methylbutyl, 1,1,3,3-tetramethylbutyl, cyclohexyl, 2-methylcyclohexyl, 3-methylcyclohexyl or 2,3-dimethylcyclohexyl.

14. A process according to claim 9, wherein the additive is a compound of the formula (IB),
y is 2 or 3,
when y is 2, Y₀ is the group of the formula 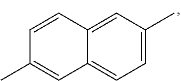
and
when y is 3, Y₀ is the group of the formula 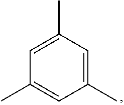
and
the radicals Y₁ independently of one another are 1,1-dimethylethyl, 1-methylpropyl, 2-methylpropyl, 1,1-dimethylpropyl, 1,2-dimethylpropyl, 2,2-dimethylpropyl, 1-ethylpropyl, 1-methylbutyl, 2-methylbutyl, 3-methylbutyl, 1,1,3,3-tetramethylbutyl, cyclohexyl, 2-methylcyclohexyl, 3-methylcyclohexyl or 2,3-dimethylcyclohexyl.

15. A process according to claim 9, wherein the additive is a compound of the formula (IC), z′ and z″ independently of one are another 1 or 2, and
when the sum of z′ and z″ is 2, Z₀ is the group of the formula 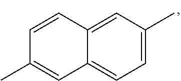
and
when the sum of z′ and z″ is 3, Z₀ is the group of the formula 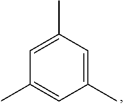
and
the radicals Z₁ and Z₂ independently of one another are 1,1-dimethylethyl, 1-methylpropyl, 2-methylpropyl, 1,1-dimethylpropyl, 1,2-dimethylpropyl, 2,2-dimethylpropyl, 1-ethylpropyl, 1-methylbutyl, 2-methylbutyl, 3-methylbutyl, 1,1,3,3-tetramethylbutyl, cyclohexyl, 2-methylcyclohexyl, 3-methylcyclohexyl or 2,3-dimethylcyclohexyl.

16. A process according to claim 9, wherein the additive is
1,3:2,4-di(benzylidene) sorbitol
1,3:2,4-di-(4-ethylbenzylidene) sorbitol,
1,3:2,4-di-(4-methylbenzylidene) sorbitol,
1,3:2,4-di-(3-methylbenzylidene) sorbitol, or
1,3:2,4-di-(3,4-dimethylbenzylidene) sorbitol.

17. A process according to claim 1, wherein the thermoplastic polymer is polypropylene, polyethylene, any polypropylene copolymer or any polyethylene copolymer or any of their blends.

18. A process according to claim 1 being applied for the purpose of extrusion of a melt containing a thermoplastic polymer for the manufacture of thin-walled profiles, cast or blown films, sheets, wires or cables.

19. A process according to claim 1 being applied for the purpose of preventing melt fracture during processing of a melt containing a thermoplastic polymer.

20. A process according to claim 1 being applied for the purpose of preventing melt fracture during processing of a melt containing a thermoplastic polymer for the manufacture of thin-walled profiles, cast or blown films, sheets, wires or cables.
